(19) United States
(12) Patent Application Publication
(10) Pub. No.: US 2002/0178666 A1
(43) Pub. Date: Dec. 5, 2002

(54) Siding system component and related method

(76) Inventors: Erik K. Jurvis, (US); Rochelle G. Jurvis, (US)

Correspondence Address: OWENS CORNING, 2790 COLUMBUS ROAD, GRANVILLE, OH, 43023, US

(21) Appl. No.: 09/873,144

(22) Filed: Jun. 1, 2001

(51) Int. Cl. E04B 1/10; E04C 1/00; B44F 7/00; B44F 9/00; E04C 3/00

(52) U.S. Cl. 52/233; 52/313; 52/287.1; 52/459

(57) ABSTRACT

A component for a siding system is disclosed. In one embodiment, the component includes an elongated body for positioning against the wall of a building or dwelling in a vertical orientation. The body may include an outwardly bowed portion that simulates the appearance of a log or timber. The component also includes first and second receivers projecting in opposite directions. When the component is vertically oriented against the wall, each receiver is adapted for receiving and at least partially covering a portion of a plurality of horizontally extending siding strips.

### TECHNICAL FIELD AND INDUSTRIAL APPLICABILITY OF THE INVENTION

The present invention relates generally to the construction/wall covering art and, more particularly, to a component for a siding system capable of receiving the ends of adjacent, horizontally extending siding strips covering the wall of a building, dwelling, or the like.

### BACKGROUND OF THE INVENTION

The art of constructing dwellings or like structures from natural logs or timbers is well known, and for many homeowners is desirable for the natural, rustic look and feel afforded as a result of this type of construction. Despite significant technological advances in recent years and the proliferation of commercial enterprises offering custom building services, constructing an entire dwelling from logs or timbers remains an expensive, time consuming and labor intensive undertaking, requiring countless man hours and a great deal of natural resources to complete.

In recent decades, a concern has also arisen over the excessive exploitation of natural resources, such as timber. This concern has prompted many in the construction art to switch to building materials fabricated of metal, vinyl, or the like. Another potential shortcoming is that, unless properly constructed by experts, dwellings formed of logs or timbers may lack the ability to contain properly conditioned air and keep out moisture, both of which may significantly increase the overall cost of owning such a dwelling.

As an alternative to using actual logs or timbers, others in the past have proposed various types of siding members, such as strips fabricated of vinyl or like materials, having outer surface indicia simulating the appearance of a natural log or timber. When a plurality of these siding strips are applied to the outside of a dwelling or other structure in an abutting or overlapping relationship, the appearance of a traditional log cabin is simulated, yet conventional construction materials are employed beneath the siding strips to provide the structural framework for the dwelling. As should be appreciated, siding strips formed of vinyl or the like are cheaper than wood per unit, easier to install, lighter in weight, relatively durable and generally resistant to the effects of moisture. Also, the use of conventional building materials beneath the siding strips (i.e., framed wall construction with insulation, an outer layer of wood sheeting, and an inner layer of drywall sheeting) improves the overall efficiency of the dwelling in terms of energy containment.

Despite these advantages, past proposals for vinyl siding, including siding of the type used to simulate the appearance of a cabin or dwelling formed of logs, are generally lacking in some key respects. For instance, in the case of simulated log siding, those in the past have paid a great attention to detail to realistically simulating the meeting of logs at the corners of the dwellings, and in particular, the inside and outside corners of vertical walls. Examples are found in U.S. Pat. Nos. 4,777,773 to Fry, 5,586,422 to Hoffner, and 5,878,542 to Cornelius, the disclosures of each of which are incorporated herein by reference.

However, these and all other known proposals generally ignore the need for pieces or components that receive and at least partially cover the adjacent ends of horizontally extending siding strips meeting along a planar wall surface. While the adjacent ends of the strips could simply be placed in an abutting relationship, a gap is inevitably created. This gap may allow water or the like to penetrate behind the siding, which may deleteriously deteriorate and weaken the wood or other material forming the planar wall. Also, in the case of a simulated log siding system, the periodic appearance small gaps, combined with the absence of the vertically extending joiner logs or timbers commonly used as intermediate supports in a real log cabin or dwelling, detracts from the realism of the simulation. Accordingly, an improved component for receiving the ends of the strips in a siding system, including one that simulates the appearance of log siding, is needed.

### SUMMARY OF THE INVENTION

The present invention relates generally to a component for use in a siding system. In one application, the component is capable of being oriented vertically along a wall in a dwelling for receiving the ends of adjacent, horizontally extending siding strips. Additionally, the component: (1) is easy and inexpensive to manufacture; and (2) requires a minimum amount of time and effort to install. The component may also be specially adapted to provide a simulated, but realistic, appearance of a vertically extending log of the type that receives and supports adjacent horizontally extending logs or other structural members in a cabin or like structure.

In accordance with a first aspect of the invention, a component for receiving a portion of a plurality of horizontally extending siding strips in a siding system for covering a substantially flat or planar wall of a building or dwelling is provided. The component comprises an elongated body for abutting against the substantially planar wall, with the body including first and second receivers projecting in opposite directions. Each receiver is adapted for receiving a portion of one or more of the plurality of horizontally extending siding strips extending along the substantially planar wall.

In one embodiment, an integral fastener receiving section is provided adjacent to each receiver. The fastener receiving section is adapted for abutting with the adjacent wall when the body of the component is in the installed position. The body may also include an outwardly bowed portion integrally connected to a portion of each of receiver. In the case of a simulated log siding system, the outwardly bowed portion may include indicia to simulate the appearance of a vertically extending log.

Preferably, each receiver is substantially U-shaped and includes a first wall for at least partially covering the end of the corresponding horizontally extending siding strip and an end wall. The end walls of the receivers may be substantially parallel and spaced apart so as to define a cavity in the body of the siding component.

In accordance with a second aspect of the invention, a siding system for covering a substantially planar portion of a wall in a building or dwelling is provided. The system comprises: (1) at least one first siding strip and at least one second siding strip, with each of the siding strips extending substantially horizontally along the wall; and (2) at least one siding component extending vertically along the wall, with the component including first and second opposed receivers for receiving a portion of the first and second siding strips extending horizontally along the substantially planar portion of the wall.

In the preferred embodiment, the first and second siding strips are aligned in substantially the same vertical plane, as well as in the same horizontal plane, in the installed position on the wall. Each receiver in the siding component is substantially U-shaped for receiving the end of the first or second siding strip. Specifically, each receiver includes a first wall for at least partially covering the end of the corresponding horizontally extending siding strip, an end wall connected to the first wall, and a fastener receiving portion connected to the end wall for abutting with the wall of the building or dwelling. The system may also include a fastener for extending through each fastener receiving section to secure the component to the wall.

In accordance with a third aspect of the invention, a method for installing a plurality of parallel, horizontally extending siding strips on a wall is disclosed. The method comprises vertically orienting an elongated siding component having first and second receivers extending in opposite directions adjacent to the wall, inserting a first end of a first one of the plurality of horizontally extending siding strips in one of said first and second receivers, inserting a second end of a second one of the plurality of horizontally extending siding strips in the other of said first and second receivers, and affixing the first and second siding strips to the wall. In the case where each receiver includes a fastener receiving section for abutting with the wall, the method may further include affixing the component to the wall by placing at least one fastener though each fastener receiving section.

### BRIEF DESCRIPTION OF THE DRAWINGS

FIG. 1 is an elevational view of one side or wall of a structure such as a dwelling or building having one embodiment of a vertically extending component for receiving the adjacent ends of horizontally extending siding strips;

FIG. 2 is a partially cutaway cross-sectional view of the vertically extending component installed on a stable support structure, such as a wall; and

FIG. 3 is a partially cutaway perspective view of the receiver component apart from the wall and oriented with a major axis in alignment with a vertical plane.

### DETAILED DESCRIPTION AND PREFERRED EMBODIMENTS OF THE INVENTION

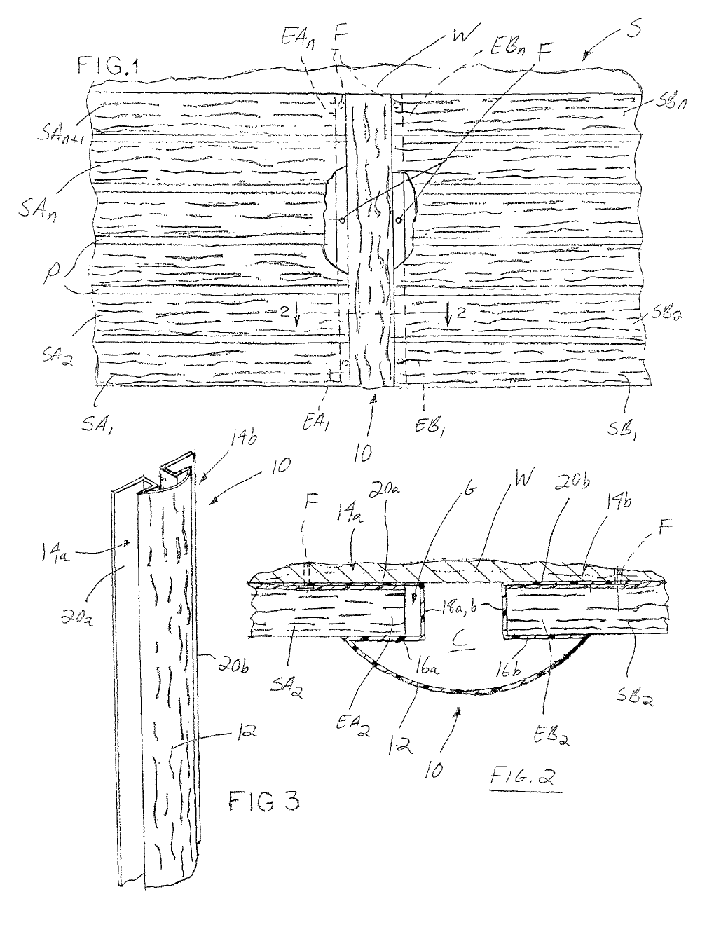

Reference is now made to FIG. 1, which illustrates a wall W of a dwelling (not shown) covered by siding S. Conventionally, the wall W is formed of one or more sheets of plywood or oriented strand board (OSB) sheeting. These sheets are typically nailed or otherwise fastened to the underlying framed construction (not shown) formed of structural members, such as A2×4s,@ oriented as vertically extending Astuds@ that rigidify and support the wall W.

In the typical siding system, a plurality of siding strips SA₁, . . . SAₙ, are applied or affixed to the surface of the wall W. Specifically, as shown in FIG. 1, a first siding strip SA₁ is horizontally oriented and affixed to the wall W, such as by using a fastener (not shown). A second siding strip, labeled SA₂, is then horizontally oriented, positioned adjacent to the siding strip SA₁ (possibly in an interlocking relationship, as mentioned in the description that follows), and affixed to the wall W. This pattern is repeated by sequentially positioning the next-in-line horizontally siding strip SAₙ₊₁ adjacent to the previously applied siding strip SAₙ to form a battery of siding strips SA₁ . . . SAₙ that ultimately cover and protect the wall W from the outside environment.

In the case where the siding strips SA₁ . . . SAₙ are of a fixed, relatively short length relative to the wall W, it is of course necessary to provide a second battery of siding strips, labeled SB₁ . . . SBₙ in FIG. 1, at a position directly adjacent to the first battery of siding strips SB₁ . . . SBₙ in a similar fashion. However, as noted above, it is generally undesirable to simply abut the ends of the siding strips SA₁ . . . _{San}, SA₁ . . . SAₙ, since this may result in unsightly gaps which otherwise detract from the simulation.

Instead, it is desirable to simulate the Ajoining@ of the ends EA₁ . . . EAₙ, EB₁ . . . EBₙ of the siding strips SA₁ . . . SAₙ, SB₁ . . . SBₙ extending along the substantially planar wall W. To accomplish this simulation, a specialized siding component 10 is provided. The component 10 is adapted for receiving the adjacent ends EA₁, EB₁ of each pair of siding strips SA₁ . . . SAₙ, SB₁ . . . SBₙ covering the wall W. Specifically, and as perhaps best shown in FIGS. 2 and 3, the component 10 includes a front portion 12 and a pair of opposed receivers 14a, 14b. Together, the front portion 12 and receivers 14a, 14b serve to at least partially cover the adjacent siding strip ends EA₁ . . . EAₙ, EB₁ . . . EBₙ to give the simulated appearance that the strips SA₁ . . . SAₙ, SB₁ . . . SBₙ extending in common horizontal planes are supported by the component 10.

In the illustrated embodiment, the front portion 12 of the component 10 is outwardly bowed or curved relative to the vertical plane to simulate the appearance of a Ahalf-round@ log or timber. Alternatively, the front portion 12 may be square, rectangular, or formed having any other cross-sectional configuration. The particular shape may be chosen depending on the overall appearance or simulation desired for the particular building or dwelling.

The opposed receivers 14a, 14b are preferably C-shaped or U-shaped and adapted for slidably receiving the ends EA₁, EB₁ of the pairs of adjacent siding strips SA₁, SB₁ extending in common vertical and horizontal planes along the wall W. Each receiver 14a, 14b includes a first wall 16a, 16b for at least partially covering the ends EA₁ . . . EAₙ, of the corresponding horizontally extending siding strips SA₁ . . . SAₙ and an end wall 18a, 18b against which the ends of the strips may abut, if necessary. Hence, the receivers 14a, 14b are constructed in the illustrated embodiment such that a horizontal centerline drawn across the open ends for receiving the strips SA₁ . . . SAₙ, SB₁ . . . SB₂ are aligned and oriented in a common vertical plane.

In the illustrated embodiment, the end walls 18a, 18b are preferably substantially parallel to each other and spaced apart. As a result of this spacing, it should be appreciated that the end walls 18a, 18b, together with the integrally connected front portion 12 define an internal cavity C. Without departing from the broadest aspects of the invention, it is possible to combine the end walls 18a, 18b into a single end wall (not shown), for use either with an outwardly bowed front portion 12 or a substantially flat front portion (not shown). In the latter case, the component 10 would of course have a cross-section that is substantially H-shaped (not shown), as compared to the Amushroom cap@ cross-section created by the outwardly bowed front portion 12 in the illustrated embodiment. Alternatively, the first walls 16a, 16b may join across the space between the end walls 18a, 18b to create a similar shape (not shown).

Connected to each end wall 18a, 18b is a fastener receiving portion or section 20a, 20b. These sections 20a, 20b are adapted to be placed flush with the wall W and project beyond the outermost edge of the first walls 16a, 16b in the vertical plane. To affix the component 10 to the wall W, one or more fasteners F, such as nails, screws, staples, or the like are placed at spaced intervals along the component 10 at any necessary or desired interval to securely fasten it to the adjacent wall W (see FIG. 1). Although two sections 20a, 20b are shown in the illustrated embodiment, it is within the broadest aspects of the invention to provide only a single elongated fastener receiving section 20a or 20b, with the other section being coextensive with the corresponding first wall 16a, 16b or eliminated entirely (not shown).

In use, the component 10 is normally oriented such that a major axis or vertical centerline thereof is parallel to a vertical plane. In the special case where the outwardly bowed front portion 12 is provided to simulate the appearance of a Ahalf-round@ log or timber, the vertical orientation of the component 10 provides the appearance of the intermediate member or log typically used to support the adjacent ends of horizontally extending logs or timbers. To enhance the realism of the simulation, and as shown in FIGS. 1-3, the outwardly bowed front portion 14 may further include indicia I to simulate the appearance of a vertically extending log. Preferably, this portion 14 is also formed of a colored material that corresponds in shade to that of the siding strips. Alternatively, a contrasting color may be used to create a different visual effect.

Conventionally, the component 10, like each siding strip SA₁ . . . SAn, SB₁ . . . SBₙ is elongated and fabricated of vinyl, plastic, aluminum, a composite such as a glass fiber reinforced polymeric material, or other well-known materials, and particularly those conventionally used to fabricate siding. Such materials are inexpensive, durable, and generally provide the component 10 with an inherent resiliency that makes it somewhat resistant to crushing as the result of an externally applied impact force (such as the force created by hail, wind, rain, etc., or even the foot or hand of a worker during installation).

Optionally, the body of each strip SA₁ . . . SAₙ, SB₁ . . . SBₙ may include an integral portion P having a contrasting surface (preferably white or light grey) as compared with other portions of the strip and adjacent strips. Thus, when a plurality of strips are provided with a shape and/or surface indicia that simulates the appearance of a log and mounted in an abutting or overlapping fashion on the side of the stable mounting structure, such as the building or dwelling, the contrasting appearance of the exposed grout or chinking portion P between each strip realistically simulates the appearance of a log cabin or like structure (see FIG. 1). The strips SA₁ . . . SAₙ, SB₁ . . . SBₙ may also include an optional channel (not shown) for receiving a portion extending along the lateral side edge of an adjacent or next-in-line strip to form an interlocking engagement. A detailed description of one version of a siding strip having an integral chinking portion and a channel of the type described above may be found in commonly assigned, co-pending application Ser. No. 09/624,672, the disclosure of which is incorporated herein by reference.

To install the siding system onto the wall W, the strips SA₁ . . . SAₙ are measured, if necessary, and the approximate position of the termination point of each end EA₁ . . . EAₙ is marked on the wall W. The component 10 is then vertically oriented, as shown in FIG. 3, and placed against the wall W such that each fastener receiving section or portion 20a, 20b is flush therewith. The fasteners F are then placed through the fastener receiving sections 20a, 20b as desired along the length of the component 10 to ensure that a secure, firm attachment is established.

The siding strips SA₁ . . . SAₙ are then installed on the wall W such that the end EA₁ . . . EAₙ of each projects into the corresponding receiver 14a. The strips SA₁ . . . SAₙ may be of the interlocking type, as disclosed in the above-referenced commonly assigned pending application, or may be of any known type in the art. In either case, a fastener, such as a nail, screw, staple, or the like, may be used to secure each strip SA₁ . . . SAₙ to the wall W.

It should be appreciated that in the illustrated embodiment, the receiver 14a is generally oversized in Adepth@ as a result of the strategic positioning of the endwall 18a towards the middle of the component 10. Generally, this oversizing makes it unnecessary to precisely position the component 10 such that the strip ends EA₁ . . . EAₙ contact the end wall 18a, since the overhang created by the first wall 16a advantageously provides a covering function. Indeed, assuming that the location of the strips SA₁ . . . SAₙ are each fixed at the opposite end (not shown), it is actually desirable to position the component 10 such that the ends EA₁ . . . EAₙ are not completely flush with the end wall 18a (note gap G in FIG. 2 between the siding strip end EA₂ and the endwall 18a), since any mistake in the estimate may necessitate trimming and increase the overall installation effort. Of course, by carefully simulating the positioning of the strips, such as strip SA₁, and the component 10 beforehand, the need for trimming may be eliminated.

Once the first portion of one or more of the strips SA₁ . . . SAₙ are in position, one or more of the strips SB₁ . . . SBₙ may be installed in place along the opposite side of the component 10, such as by using fasteners. Again, depending on the length of the strips SB₁ . . . SBₙ and the positioning of the corresponding receiving structure at the opposite end, trimming may be necessary. However, to the extent of the overhang created by the first wall 18b of the receiver 14b, the strips SB₁ . . . SBₙ may be moved laterally as necessary to avoid the need for trimming at the opposite ends.

The foregoing description of the various embodiments of the invention is presented for purposes of illustration and description. It is not intended to be exhaustive or to limit the invention to the precise form disclosed. Obvious modifications or variations are possible in light of the above teachings. The embodiments described provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

1. A component for receiving a portion of a plurality of horizontally extending siding strips in a siding system for covering a substantially flat or planar wall of a building or dwelling, comprising:
an elongated body for abutting against the substantially planar wall, said body including first and second receivers projecting in opposite directions, each for receiving a portion of one of the plurality of horizontally extending siding strips along the substantially planar wall.

2. The siding system component according to claim 1, further including an integral fastener receiving section adjacent to each receiver in abutment with the wall.

3. The siding system component according to claim 2, further including an outwardly bowed portion integrally connected to a portion of each of said receivers.

4. The siding system component according to claim 3, wherein said outwardly bowed portion includes indicia to simulate the appearance of a vertically extending log.

5. The siding system component according to claim 1, wherein each receiver is substantially U-shaped and includes a first wall for at least partially covering the end of the corresponding horizontally extending siding strip.

6. The siding system component according to claim 1, wherein each receiver includes an end wall.

7. The siding system component according to claim 6, wherein the end walls are substantially parallel and spaced apart.

8. The siding system component according to claim 1, wherein each receiver includes:
a first wall for at least partially covering the end of the corresponding horizontally extending siding strip;
an end wall connected to said first wall; and
a fastener receiving portion connected to said end wall for abutting with the wall of the building or dwelling.

9. The siding system component according to claim 8, wherein the first wall of each said receiver is integrally connected to an end of an outwardly bowed portion that simulates the appearance of a log or timber.

10. The siding system component according to claim 9, wherein the fastener receiving portion is elongated relative to the first wall of the corresponding receiver.

11. A siding system for covering a substantially planar portion of a wall in a dwelling, comprising:
at least one first siding strip and at least one second siding strip, said siding strips extending substantially horizontally along the wall;
at least one siding component extending vertically along the wall, said component including first and second opposed receivers for receiving a portion of the first and second siding strips extending horizontally along the substantially planar portion of the wall.

12. The siding system according to claim 11, wherein the first and second siding strips are positioned in substantially the same vertical plane.

13. The siding system according to claim 11, wherein the first and second siding strips are positioned in substantially the same horizontal plane.

14. The siding system according to claim 11, wherein each receiver is substantially U-shaped and includes:
a first wall for at least partially covering the end of the corresponding horizontally extending siding strip;
an end wall connected to said first wall; and
a fastener receiving portion connected to said end wall for abutting with the wall of the building or dwelling.

15. The siding system according to claim 14, further including at least one fastener for fastening each said fastener receiving section to the wall.

16. The siding system component according to claim 14, wherein the first wall of each said receiver is integrally connected to an end of an outwardly bowed portion that simulates the appearance of a log or timber.

17. A method for installing a plurality of horizontally extending siding strips on a wall, comprising:
vertically orienting an elongated siding component having first and second opposed receivers adjacent to the wall;
inserting a first end of a first one of said plurality of horizontally extending siding strip in one of said first or second receivers;
inserting a second end of a second one of said plurality of horizontally extending siding strip in the other of said first or second receivers;
affixing the first and second siding strips to the wall.

18. The method according to claim 17, wherein each receiver includes a fastener receiving section for abutting with the wall, and the method further includes affixing the component to the wall by placing at least one fastener though each fastener receiving section.
